(19) United States
(12) Patent Application Publication
(10) Pub. No.: US 2003/0141485 A1
(43) Pub. Date: Jul. 31, 2003

(54) Long term-stabilized magnesium hydroxide suspension for covering iron mineral, a process for its production and application

(76) Inventors: Cesar-Emilio Zertuche-Rodriguez, Monterrey (MX); Ricardo Benavides-Perez, Monterrey (MX); Jose-Gertrudis Bocanegra-Rojas, Monterrey (MX)

Correspondence Address: ABELMAN FRAYNE & SCHWAB, Attorneys at Law, 150 East 42nd Street, New York, NY, 10017, US

(21) Appl. No.: 10/053,315

(22) Filed: Jan. 17, 2002

(51) Int. Cl. C09K 3/00; B27K 1/00; B01F 17/00; B01F 3/12

(52) U.S. Cl. 252/382; 516/88

(57) ABSTRACT

A long term stabilized magnesium hydroxide suspension which can be used for covering pellets of several materials in order to avoid the agglomeration of a plurality of pellets when stored or subjected to a heat treatment and which can be stored for at least three months without substantial agitation and without experiencing substantial settlement and solid hard substrate formation, comprising a solid content of about 51% to 61%; a water content of about 39% to 49%; a viscosity of about 500 to 1,500 cp.; an average particle size of about 1 to 2.5 microns; a Mg(OH)₂ content of about 50% to 60%; an equivalent magnesium oxide content of 34% to 42%; including an adherent compound at a concentration of at least 30% in an amount of 0.5 to 5%, by weight, on a dry basis and an anionic polyelectrolyte as a dispersant agent, and which is obtained by washing, filtering and repulping magnesium hydroxide solids to obtain agglomerated solid particles, dispersing the agglomerated solid particles by comminution in a dispersing equipment, to reduce the particle size providing a dispersed product, grinding the dispersed product, to additionally reduce the particle size to about 2 microns; and adding an adherent compound at a concentration of at least 30% in an amount of 0.5 to 5% on a dry basis and an anionic polyelectrolyte at a concentration of at least 25%, in an amount of about 0.5 to 2.5%, by weight, on a dry basis, as a dispersant agent.

### BACKGROUND OF THE INVENTION

A. Field of the Invention

This invention relates to a stabilized magnesium hydroxide suspension and, more particularly, to a long term-stabilized magnesium hydroxide suspension, having a stability of at least three months without substantially settling and without forming a hard solid substrate, for covering pellets of several materials to avoid adhesion between differing materials covering the pellets and thus preventing agglomeration of the pellets when stored or subjected to a heat treatment at a high temperature inside a furnace, and a process for its production and application.

B. Description of Related Art

In some treatments of bricks or pellets of materials such as dolomite, iron mineral, etc., in which it is necessary to sinter a plurality of bricks inside furnaces at high temperatures, there exists a tendency of said bricks or pellets to adhere to each other producing an agglomerate of bricks.

One of these treatments is the iron reduction of mineral iron powder and pellets inside a furnace at high temperatures. When the sintering is complete, usually some or all of the pellets are agglomerated in a solid mass which obstruct the furnace exit and makes necessary to apply a mechanical shock in order to separate each pellet from the agglomerate.

In order to avoid the agglomeration of the pellets during sintering, several compounds were tested which must be applied to the pellets surface before the sintering process. Among these compounds, there were tested slurries of magnesium hydroxide, calcium hydroxide, bauxite and even cement, but none of these compounds produced the expected results and had some disadvantages when used for the purpose referenced above.

Some of the principal disadvantages, in common with all the compounds previously mentioned, are that the compounds must be continuously stirred to maintain a constant concentration, and that once the compound was applied to the pellets, the compounds proved to have a very poor adherence to the pellets, since the cover, once it dries, tends to separate from the pellet simply by the movement produced by the normal manipulation of the pellets.

The magnesium, and particularly the magnesium hydroxide, has a great number of applications, such as a flame retardant, neutralization of acid waste streams, as well as for pharmacological purposes and detergent production.

In some production plants, the magnesium hydroxide is produced from a magnesium chloride brine and burnt dolomite, in order to obtain dead burned magnesium oxide, to be used mainly in the manufacture of refractory bricks.

Other methods for the production of magnesium hydroxide are:

Production of magnesium hydroxide by reacting dolomite or limestone with sea water or chloride or magnesium brines.

Production of magnesium hydroxide by thermal decomposition of chloride or magnesium brines.

Production of magnesium hydroxide by burning natural magnesite (magnesium carbonate) in order to obtain magnesium oxide which afterwards is hydrated with water in order to obtain magnesium hydroxide.

Production of magnesium hydroxide by hydrating low cost magnesium oxide (such as that which originates in China).

Production of magnesium hydroxide by reacting sodium hydroxide with magnesium sulfate or Epsom salt.

Production of magnesium hydroxide from sodium hydroxide and chloride and magnesium brines.

From ammonia or ammonium hydroxide with chloride or magnesium brines.

Looking for product diversification and added value for the product, trials were carried out for the production of magnesium hydroxide for the covering of pellets and iron powder

The first trials commenced by using a magnesium hydroxide paste obtained by: mixing burned dolomite and magnesium chloride brine in order to obtain a reaction between both compounds; washing the product of said reaction and conditioning the product in order to obtain a suspension having a high covering area per gram of substance (surface area covered by each gram of substance) and a viscosity of less that 100 centipoises, which would allow its being pumped by any kind of pumping means such as a centrifugal pump, a diaphragm pump or a peristaltic pump. Said suspension was subsequently conditioned by the addition of an adherent compound by which the viscosity of the suspension was increased to approximately 1,000 centipoises.

When is necessary to send the magnesium hydroxide paste or suspension to locales remote from the production plant, as well as for further processing, it is necessary to store a magnesium hydroxide suspension for long terms in a storage container. Under such circumstances, the solid particles of the suspension normally tend to settle out producing a hard solid substrate as a hard cake in the bottom of the storage container, which is often very difficult to remove. The remaining suspension under such circumstances, results in a useless material since it doesn't have the required magnesium hydroxide concentration nor the required particle size in suspension and, therefore, it has to be poured from the storage container and discarded in order to remove the hard solid cake from the bottom of the container, resulting in increased costs and high raw material losses.

Therefore, it would be highly desirable to produce a magnesium hydroxide suspension which can be used for covering pellets of a variety of materials in order to avoid the agglomeration of a plurality of pellets when stored or subjected to a heat treatment thereof, while providing the product with good adhesive properties and the capability of being stored for long periods of time without substantial settling and cake formation.

U.S. Pat. No. 4,743,396 disclose a magnesium hydroxide slurry, for very specific purposes, having a concentration of 50% by weight or higher of Mg(OH)₂ and 0.1 to 5% of a sulfomethylated polyacrylamide which allows the slurry to be pumped through pipelines.

Furthermore, U.S. Pat. No. 4,164,521 (involving the use of a polyanionic polymer containing at least 50% mole of repetitive units derived from an acrylic acid and a polycathionic polymer); U.S. Pat. No. 4,412,844 (involving the use of 1.0 to 8.0% of a water dispersible, oil-soluble emulsifying agent); U.S. Pat. No. 4,155,741 (including an encapsulated material); and U.S. Pat. No. 3,957,674 (including at least 0.5% of sodium naphtalen-sulfonate), all disclose suspensions which when stored, showed some settlement but with the difference that when they are agitated, they recover their concentration and physical properties, but none of them disclose a long term stability of about three months.

Because of its nature, a stabilized suspension can be more easily pumped than one which is not stabilized because the non-stabilized suspension tends to form thickened particles and solid substrates complicating or even impeding its being pumped.

PCT published patent application No. PCT/AU95/00446 discloses an example of a magnesium hydroxide suspension having both characteristics of pumpability and stability for about seven days without substantial agitation.

However, until now, there has been no suspension on the market having a long term stability of about three months and which can be used for covering pellets.

In accordance with the present invention, a 50-60% magnesium hydroxide suspension, called “Femag HL” having a solid content between about 51% to 61%, a water content of from about 39% to 49%, a viscosity of about 1000 centipoises (cp)., a particle size of about 2 microns, a chloride content less than about 0.6%, a calcium content of less than about 1%, a pH greater than about 10, an equivalent magnesium oxide content of about 34% to 42%, a specific gravity of about 1.42 to 1.52, and including one or more anionic polyelectrolytes as a dispersant agent, at a concentration of at least about 25%, in an amount of about 0.5 to 2.5% on a dry basis, and an adherent compound developed specifically for the above referred purpose called “GBC200” comprising an acrylic-styrene emulsion, at a concentration of at least about 30% in an amount of about 0.5 to 5%, preferably about 1.5% to 2% on a dry basis, exhibiting a stability of at least three months without substantial agitation, and which be used for covering pellets of several kinds of materials in order to avoid the agglomeration thereof when treated at high temperatures, is provided by a new process which will be disclosed below.

Because of the particle size (of about 2 microns) in combination with the use of the anionic polyelectrolyte as a dispersant agent, the three months stability of the “Femag HL” product is guaranteed. In fact this product requires only somewhat (not vigorous) agitation once a day, in order to keep it fluid without experiencing particle thickening or substantial settlement resulting in the formation of a hard cake.

Regarding the process for producing such magnesium hydroxide suspensions, these can be produced by adding a soluble alkaline material to an aqueous salt of magnesium at atmospheric pressure and at a temperature from a near ambient temperature to about 100° C.

U.S. Pat. No. 5,487,979 discloses a process for the production of magnesium hydroxide suspension, by pressure hydrating burnt natural magnesite in the presence of chlorine ions and a cationic polymer (polyamide).

U.S. Pat. Nos. 5,143,965; 4,548,733; 4,430,248; 4,230,610; 4,166,040; and 4,166,041 disclose representative processes for producing magnesium hydroxide suspensions, by using ultrasonic mixing steps and some cationic polymers such as ammonium metacriloxiethyl-trimethyl-methasulfonate and polyacrylic acid, among others, showing more or less stability, but none disclosing a stability in the range of about three months.

It is therefore highly desirable to provide a new process for producing a magnesium hydroxide suspension which can be used for covering pellets of several kinds of materials in order to avoid the agglomeration of a plurality of pellets when stored or subjected to a heat treatment and which, in addition, can be stored for long periods of time without substantial settling and avoiding cake formation.

The process to produce the magnesium hydroxide suspension in accordance with the present invention, comprises dispersing a Mg(OH)₂paste, comprising agglomerated Mg(OH)₂ crystals having a particle size of about 4.0 microns, by comminuting the solid paste to reduce the particle size in comminuting equipment, such as one having a cutting disc, for example, polypropylene stainless steel, rotating at a speed in the range of about 1,200 to 3,000 RPM., and by including an anionic polyelectrolyte, as a dispersing agent, at a concentration of about 25%, in an amount of about 0.5 to 2.5% by weight on a dry basis; subjecting the mixture to a grinding step in equipment which employs, for example, zirconium silicate or stainless steel balls as grinding agents, to reduce the particle size to about 2 microns; adding an adherent compound at a minimum concentration of about 30% in an amount of about 0.5 to 5% on a dry basis, and, dispersing the resulting suspension for about 10 minutes, to provide the suspension with a long-term stability of at least about three months without substantial agitation, and which does not settle out to form a hard solid cemented cake. The magnesium hydroxide suspension formed in this manner can be used for covering pellets and iron powder of several kinds of materials, such as iron pellets to avoid the agglomeration of a plurality of pellets when stored or subjected to a heat treatment thereof when treated at high or elevated temperatures. The magnesium suspension formed by the process of the present invention applied to the surface of said pellets by means of a plurality of spraying nozzles, which are passed thereunder by means of a conveyor belt.

The magnesium hydroxide suspension of the present invention has a high coverage area per gram (between about 7 to 20 m²/g) and it can be applied on the surface of the pellets and the iron powder as a diluted suspension at different concentrations between about 4 and 15%. Furthermore, the magnesium hydroxide covering adheres strongly to the pellets and does not separate from the surface of the pellets during transportation, manipulation and treatment.

By covering the pellets with the magnesium hydroxide suspension of the present invention there are obtained the following benefits:

Lower maintenance costs of conveyor belts, rollers, sieving devices, etc.

Easier product manipulation procedures.

Reduced emanation of hazardous and polluting elements to the environment.

High quality iron pellets are obtained.

Benefits to the steel industry with respect to slag fluidity.

### SUMMARY OF THE INVENTION.

It is therefore a main object of the present invention, to provide a magnesium hydroxide suspension for covering pellets of several kinds of materials for avoiding its agglomeration thereof when treated at high temperatures, having good adherence properties and a high covering area per gram of suspension.

It is another object of the present invention, to provide a magnesium hydroxide suspension of the above disclosed nature, having a stability of at least three months without substantial agitation, having a very low tendency to settle down and forming a hard cemented cake.

It is a further object of the present invention, to provide a magnesium hydroxide suspension of the above disclosed nature, having an adherent compound content, at a concentration of at least about 30%, in an amount of about 0.5 to 5% on a dry basis.

It is yet a further object of the present invention to provide a magnesium hydroxide suspension of the above disclosed nature having a Mg(OH)₂ content of about 50% to 60%.

It is still another object of the present invention to provide a magnesium hydroxide suspension of the above disclosed nature having a solids content of about 52% to 62%.

It is still a further object of the present invention to provide a magnesium hydroxide suspension of the above disclosed nature having a particle size of about 2 microns.

It is still yet another object of the present invention, to provide a magnesium hydroxide suspension, of the above disclosed nature, having a viscosity of about 1,000 cp. (less than 1,500 cp.), a chloride content between about 0.2% to 0.6%, a calcium content of about 0.3% to 1.0%, a pH of about 10.5 to 12, an equivalent magnesium oxide content of 34% to 42%, a specific gravity of about 1.42 to 1.52, a water content of about 39% to 49%, an anionic polyelectrolyte as a dispersant, at a minimum concentration of 25%, in an amount of about 0.5 to 2.5% on a dry basis, and an adherent compound content, at a concentration of at least about 30% in an amount of about 0.5 to 5% on a dry basis, which only requires stirring once a day to maintain its fluid nature.

It is also a further main object of the present invention, to provide a process to produce an hydroxide suspension for covering pellets of several kinds of materials for avoiding its agglomeration thereof when treated at high temperatures, having good adhesion properties and a high covering area per gram of suspension, and having a stability of at least three months without substantial agitation, having a very low tendency to settle down and forming a hard cemented cake, including a specific dispersing step which comminuting the solid particles at a size of about 2 microns, incorporating an anionic polyelectrolyte as a dispersant agent, at a concentration of at least 25%, in an amount of about 0.5 to 2.5% on a dry basis and adding an adherent compound at a concentration of at least about 30% in an amount of about 0.5 to 5% on a dry basis

These and other objects and advantages of the present invention will be apparent to those persons having ordinary skill in the art, from the following description of the invention, referring to specific examples of practice.

### DETAILED DESCRIPTION OF THE INVENTION

The invention will be described by making reference to a preferred embodiment and some specific examples of the process and materials used to produce the magnesium hydroxide suspension of the present invention which can be used for covering pellets of different materials in order to avoid the agglomeration thereof when treated at high temperatures and having a stability of at least three months without substantial agitation, and which has a very low tendency to settle out to form a hard solid cemented cake.

The magnesium hydroxide Mg(OH)₂ of the present invention, which is manufactured by Servicios Industriales Peñoles, S.A. de C.V. of Monterrey, Mexico under the trademark “Femag HL”, may result from the reaction of a magnesium chloride brine and “Dolime”, which is a calcium and magnesium oxide obtained from the calcination of dolomite, by the following reaction:

$${CaCO}_{3} - {MgCO}_{3} \frac{Δ}{1100 ° C .} \to CaO - MgO + {CO}_{2}^{( G )} ↑$$

| | |
|---|---|
| Dolomite | Dolime |
| Chemical Analysis | Chemical Analysis |

| | | | |
|---|---|---|---|
| MgO | 20.00% | MgO | 39.60% |
| CaO | 31.00% | CaO | 57.60% |
| Fe₂O₃ | 0.03% | Fe₂O₃ | 0.06% |
| Al₂O₃ | 0.04% | Al₂O₃ | 0.08% |
| SiO₂ | 0.04% | SiO₂ | 0.08% |
| CO₂ | 0.12% | | |

From the reaction of the magnesium chloride with the “Dolime”, a precipitated magnesium hydroxide is obtained in a calcium chloride liquor, in accordance with the following reaction:

CaO—MgO+MgCl₂+H₂O→Mg(OH)₂+CaCl₂

| | | | |
|---|---|---|---|
| Dolomite | Magnesium | Magnesium | Calcium |
| | chloride | hydroxide | chloride |
| | solution | | solution |

The process for producing the magnesium hydroxide suspension in accordance with the present invention comprises:

a washing the magnesium hydroxide;

filtering and repulping the magnesium hydroxide solids in order to obtain less than about 0.6% of chloride values; this material, which is 50% of the product, has a particle size of about 4.0 microns, which are mainly crystals of agglomerated Mg(OH)₂, having a crystal size of about 0.4 microns;

dispersing the agglomerated solid particles by comminuting in a dispersing equipment having a cutting disc of, for example, polypropylene, stainless steel, etc., rotating at a speed of about 1200 to 3000 RPM, for about 20 to 30 minutes, in order to reduce the particle size;

grinding the dispersed product in a sand mill employing, for example, zirconium silicate, glass or stainless steel balls having a diameter of less than about 1.5 mm, as a milling media, to further reduce the particle size to guarantee that at least about 50% of the product has a particle size of about 2 microns, since the finer the particle size the better the degree or level of stabilization which can be achieved;

adding one or more anionic polyelectrolytes, at a concentration of at least about 25% in an amount of about 0.5 to 2.5% on a dry basis, as a dispersant agent which favors the stability of the suspension by providing electric charges which reduces the tendency of the particles to agglomerate and settle out;

adding an adherent compound, for example, a styrene-acrylic emulsion, at a concentration of at least about 30% in an amount of about 0.5 to 5%, by weight, but preferably between about 1.5% to 2.0%, by weight, on a dry basis and dispersing the suspension with the incorporated adherent compound for about 10 to 15 minutes in dispersing equipment comprising a container, an agitator and a stainless steel and/or polypropylene cutting disc;

storing the magnesium hydroxide suspension obtained in this manner in a storage tank where it can be stored for at least three (3) months without substantial agitation without experiencing a tendency to settle out to form a hard solid cake in the bottom of the storage tank, or thickening of the solid particles of the suspension used to cover the pellets.

It has been found that the grinding step is necessary because, although the product obtained in the dispersion step has a low viscosity and consequently a good fluidity, it still does not possess the required particle size characteristics to promote the desired stability since some of the particles still have a size of about 4 to 10 microns and have a tendency to settle out, sometimes in as short a period as a few hours.

Furthermore, although the particle size obtained by the milling step results in a reduced tendency to settle out, this factor alone still does not guarantee the long term stabilization which is desired, and therefore, the anionic polyelectrolyte is necessary for obtaining the desired level of stability in combination with the proper particle size.

The anionic polyelectrolytes are macromolecules which originate from monomeric units with ionizable groups as opposed to a simple electrolyte such as sodium chloride in which the cation Na⁺ and the anion Cl⁻ are relatively small and similar in size. A polyelectrolyte is characterized by a macro-ion which is the vertebral column (a large ion having a similar number of charged groups connected by bonds) and an equivalent number of independent small charges and of opposite charge. Because of their high molecular weight these are also known as dispersant resins.

Examples of anionic polyelectrolytes are sodium polyacrylate, ammonium poly(styrene/maleate), among others.

Although the suspension of the present invention has been disclosed as being obtained from a reaction between a magnesium chloride brine and “Dolime”, the magnesium hydroxide can also be obtained from the following processes:

Production of magnesium hydroxide by thermal decomposition of chloride or magnesium brines.

Production of magnesium hydroxide by burning natural magnesite (magnesium carbonate) in order to obtain magnesium oxide which afterwards is hydrated with water in order to obtain magnesium hydroxide.

Production of magnesium hydroxide by hydrating low cost magnesium oxide (such as that which originates in China),

Production of magnesium hydroxide by reacting sodium hydroxide with magnesium sulfate or Epsom salt.

Production of magnesium hydroxide form sodium hydroxide and chloride and magnesium brines.

From ammonia or ammonium hydroxide with chloride or magnesium brines.

The following are examples of the specific process for obtaining the magnesium hydroxide suspension in accordance with the present invention.

### EXAMPLE 1

A magnesium hydroxide suspension in accordance with the present invention was prepared.

1. 8.9 kilograms of burned dolomite was reacted with 75 liters of a magnesium chloride brine in a tank while maintaining agitation to obtain a suspension of magnesium hydroxide solids and a solution of calcium chloride.

2. The magnesium hydroxide solids contained in solution were allowed to settle inside a clarifier to concentrate the magnesium hydroxide at the bottom of the clarifier.

3. The magnesium hydroxide solids were filtered, from the bottom of the clarifier, in a vacuum filter, until a paste was obtained containing 55%, by weight, of magnesium hydroxide and 45%, by weight, of a solution containing water plus calcium chloride.

4. 12 liters of water per 100 grams of paste, obtained in step 3 above, was added in order to slowly eliminate the calcium chloride by dilution.

5. The solids contained in solution were allowed to settle and then they were filtered in a vacuum filter.

6. Steps 4 and 5 were repeated two (2) more times.

7. The final suspension and the settled solids were then filtered in a vacuum filter in the absence of atmosphere to obtain a paste containing 53%, by weight, of solids and 47%, by weight, of water and having a viscosity of 4,800 centipoises and a chloride content of 0.37%, by weight.

8. The magnesium hydroxide paste was dispersed by comminuting the paste in dispersing equipment equipped with a stainless steel cutting disc which rotated at a speed of 1200 rpm for a period of fifteen (15) minutes. The dispersion of the magnesium hydroxide paste was carried out in the presence of 1.5%, by weight, of an anionic polyelectolyte having a sodium polyacrylate base (QM 600).

9. The magnesium hydroxide paste was then comminuted in a sand mill to obtain particles having a size between about 1.5 and 3 microns.

10. The magnesium hydroxide paste was dispersed again by comminuting it in dispersing equipment having a stainless steel cutting disc rotating at a speed of 1200 rpm for a period of eight minutes in the presence of a styrene acrylic emulsion, in an amount of 5% by weight, having a 50% solids content (GBC 200, Servicios Industriales Penoles, S.A. de C.V. of Monterrey, Mexico).

11. Adding an acrylic-styrene emulsion as an adherent compound.

### EXAMPLE 2

A sample of a magnesium hydroxide suspension prepared in accordance with Example 1 above was divided into three (3) portions.

Each portion was diluted with water in order to obtain concentrations of 1, 2 and 5%, respectively.

Adhesion tests were carried out for each of the samples by covering iron mineral pellets with each of the portions. An additional adhesion test was carried out using a sample containing cement at a concentration of 15% for comparison purposes, as well as another adhesion test using a control sample having no adhesion additives,

The five (5) samples were placed inside a laboratory reactor in order to carry out the mineral fusion and the following results were obtained:

| Sample | % of agglomerates remaining |
|---|---|
| Control, without additives | 87 |
| Cement suspension at 15% | 30 |
| Magnesium suspension at 5% | 4 |
| Magnesium suspension at 2% | 10 |
| Magnesium suspension at 1% | 19 |

The best results were obtained with the magnesium hydroxide suspension at 5% due to the lesser quantity of agglomerated pellets produced at the reactor exit.

### EXAMPLE 3

A sample of a magnesium hydroxide suspension prepared in accordance with Example 1 above was divided into six (6) portions.

Two portions were diluted with water in order to obtain a concentration of 2%, another two portions were diluted to obtain a concentration of 3% and the last two portions were diluted to obtain a 5% concentration.

Each portion was used to cover iron mineral pellets. Three (3) of the samples were maintained concentrations of 2, 3 and 5%, respectively, while the other three (3) samples were air blown to eliminate the excess water to determine if the adherence of the magnesium hydroxide suspension to the pellets decreased.

The six (6) samples were placed in a laboratory reactor in order to carry out the mineral fusion and the following results were obtained:

| Sample | % of agglomerates remaining |
|---|---|
| Magnesium suspension at 2% | 50 |
| Magnesium suspension at 2% air blown | 57 |
| Magnesium suspension at 3% | 15 |
| Magnesium suspension at 3% air blown | 24 |
| Magnesium suspension at 5% | 50 |
| Magnesium suspension at 5% air blown | 57 |

It can be concluded from the foregoing results that by blowing air into the samples before placing them inside the reactor, the effectiveness of the magnesium hydroxide suspension of the present invention was lost since it resulted in a greater percentage of agglomerated pellets.

### EXAMPLE 4

To each of four (4) samples of a magnesium hydroxide suspension prepared in accordance with Example 1 above there were added differing quantities of the GBC 200 additive adherent compound to each sample, ranging from 1% to 3%.

The four samples were diluted with water until a final concentration of 5% was obtained which was used to cover the iron mineral pellets. Subsequently, the pellets covered with the magnesium hydroxide suspension were placed in a reactor in order to carry out the iron fusion and the following results were obtained with regard to the adherence of the magnesium hydroxide to the pellets. A sample containing a suspension of cement at a concentration of 15% without any additive was employed as a control.

| | % of |
|---|---|
| Sample | agglomerates remaining |
| Magnesium suspension with 1% of additive | 14 |
| Magnesium suspension with 1.5% of additive | 9 |
| Magnesium suspension with 2% of additive | 8 |
| Magnesium suspension with 3% of additive | 8 |
| Cement suspension at 15% without additive | 18 |

From the above experiment it can be concluded that a lower percentage of agglomerates were obtained when 2% and 3% of the adherent compound GBC 200 compound was added.

### EXAMPLE 5

Three (3) samples of a stable magnesium hydroxide suspension prepared in accordance with Example 1 were burned at a temperature of 900° C. in order to obtain magnesium oxide.

After obtaining the magnesium oxide, water was added to the magnesium oxide in order to convert it to magnesium hydroxide and to adjust its concentration to 55%.

The suspension obtained was divided into a first, a second and a third portion, to which were added 1%, 2% and 3% of the additive adherent compound GBC 200, respectively, and diluted with water in order to obtain a magnesium hydroxide concentration of 5%.

Each sample was used to cover different iron pellets which afterwards were placed inside a laboratory reactor in order to carry out an iron fusion at a temperature of 950° C.

As a test or control sample, other iron pellets were covered with a cement suspension at a concentration of 15% and placed inside the same reactor. The following results were obtained:

| | % of |
|---|---|
| Sample | agglomerates remaining |
| Magnesium suspension with 1% of additive | 15 |
| Magnesium suspension with 2% of additive | 9 |
| Magnesium suspension with 3% of additive | 8 |
| Cement suspension at a 15% | 12 |

The best results were obtained with the hydroxide suspensions containing 2% and 3% of additive adherent compound.

Finally, it should be understood that the long term-stabilized magnesium hydroxide suspension for covering iron mineral and the process for its production and application of the present invention, is not limited exclusively to the above described and illustrated embodiments and that persons having ordinary skill in the art can, with the teaching provided by this invention, make modifications to the long term-stabilized magnesium hydroxide suspension for covering iron mineral and the process for its production and application of the present invention, which will clearly be within the true inventive concept and scope of the invention which is claimed in the following claims.

We claim:

1. A long-term stabilized magnesium hydroxide suspension adapted to cover pellets of several kinds of materials to avoid their agglomeration when treated at high temperatures, which comprises a solids content of about 51% to 61%; a water content of about 39% to 49%; a viscosity of about 500 to 1,500 cp.; an average particle size of about 1 to 2.5 microns; a Mg(OH)₂ content of about 50% to 60%; a chloride content of less than about 0.6% on a dry basis; a calcium content of less than about 1% on a dry basis; a pH of about 10.5 to 12; an equivalent magnesium oxide content of about 34% to 42%; a specific gravity of about 1.42 to 1.52, and including at least one anionic polyelectrolyte as a dispersant agent, at a concentration of at least about 25%, in an amount of about 0.5 to about 2.5%, by weight, on a dry basis and an adherent compound having a concentration of at least about 30% in an amount of about 0.5 to about 5%, by weight, on a dry basis; adapted to being stored for at least three months without substantial agitation and without experiencing substantial settlement, while avoiding the formation of a solid, hard substrate.

2. The long term stabilized magnesium hydroxide suspension as claimed in claim 1, wherein the anionic polyelectrolyte is selected from the group consisting of sodium polyacrylate and ammonium polystyrene/maleate.

3. The long term stabilized magnesium hydroxide suspension as claimed in claim 1, wherein from about 5 to 15%, by weight, of the total of solids of the suspension have a particle size of about 5 to 10 microns; from about 30 to about 40% have a particle size of about 2 to about 5 microns; from about 25 to about 35% have a particle size of about 1 to 2 microns and from about 20to about 30% have a particle size of about 0.5 to 1 microns.

4. A long term stabilized magnesium hydroxide suspension adapted to cover pellets of several kinds of materials to avoid their agglomeration when treated at temperatures of between about 900° C. to 1,000° C., which comprises a solids content of about 55%; a water content of about 44%; a viscosity of about 1,000 cp.; an average particle size of about 2.0 microns; a Mg(OH)₂ content of about 55%; a chloride content of about 0.30%; a calcium content of about 0.45%; a pH of about 11.7; an equivalent magnesium oxide content of about 38%; a specific gravity of about 1.47; and including at least one anionic polyelectrolyte as a dispersant agent, at a concentration of about 40%, in an amount of about 1%, by weight, on a dry basis and an adherent compound having a concentration of at least about 30% in an amount of about 1.5% to 2.0%, by weight, on a dry basis; adapted to being stored for at least three months without substantial agitation and without experiencing substantial settlement, while avoiding the formation of solid, hard substrate.

5. The long term stabilized magnesium hydroxide suspension as claimed in claim 4, wherein about 10% of the total solids of the suspension have a particle size of about 5 to 10 microns; 35% have a particle size of about 2 to 5 microns; 30% have a particle size of about 1 to 2 microns and 25% have a particle size of about 0.5 to about 1 microns.

6. The long term stabilized magnesium hydroxide suspension as claimed in claim 1, wherein the adherent compound is selected from the group consisting of styrene-acrylic emulsions.

7. A process for the production of a long-term stabilized magnesium hydroxide suspension from magnesium hydroxide solids, which comprises the steps of:
a) washing the magnesium hydroxide solids;
b) filtering and repulping the magnesium hydroxide solids to obtain agglomerated solid particles having less than about 0.6% of chloride values;
c) dispersing the agglomerated solid particles by comminuting in dispersing equipment to reduce their particle size to provide a dispersed product;
d) grinding the dispersed product to further reduce the particle size so that at least the 50% of the ground product has a particle size of about 2 microns;
e) adding an adherent compound, at a concentration of at least about 30% in an amount of about 0.5 to about 5%, by weight, on a dry basis;
f) dispersing the product of step e) in the dispersing equipment and;
g) adding at least one anionic polylectrolyte as a dispersant agent, at a concentration of at least about 25%, in an amount of about 0.5 to 2.5%, by weight, on a dry basis.

8. The process as claimed in claim 7, wherein step b) is carried out at least three times.

9. The process as claimed in claim 7, wherein about 50% of the dispersed product has a particle size of about 4.0 microns and comprising crystals of agglomerated Mg(OH)₂ having a crystal size of about 0.4 microns.

10. The process as claimed in claim 7, wherein the dispersing equipment used in step c) has a cutting disc rotating at about 1,200 to 3,000 RPM.

11. The process as claimed in claim 7, wherein step c) is carried out for about 20 to 30 minutes.

12. The process as claimed in claim 7, wherein step d) is carried out in a sand mill using zirconium silicate or stainless steel balls having a diameter less than about 1.5 mm.

13. The process as claimed in claim 7, wherein the anionic polyelectrolyte is selected from the group consisting of sodium polyacrylate and ammonium polystyrene/maleate, whereby the stability of the suspension is improved by providing the particles with electric charges which reduces their tendency to agglomerate, and settle out.

14. The process as claimed in claim 7, wherein the dispersing equipment used in step f) includes a stainless steel cutting disc.

15. The process as claimed in claim 7, wherein the dispersing equipment used in step f) includes a polypropylene cutting disc.

16. The process as claimed in claim 7, wherein the adherent compound is added in an amount of about 1.5% to 2.0%, by weight, on a dry basis.

17. The process as claimed in claim 7, wherein the adherent compound is selected from the group consisting of styrene-acrylic emulsions.
